(19) United States
(12) Patent Application Publication
(10) Pub. No.: US 2026/0058048 A1
(43) Pub. Date: Feb. 26, 2026

(54) COIL COMPONENT

(71) Applicant: SAMSUNG ELECTRO-MECHANICS CO., LTD., Suwon-si (KR)

(72) Inventors: Jae Wook LEE, Suwon-si (KR); Ki Dae KWON, Suwon-si (KR)

(73) Assignee: SAMSUNG ELECTRO-MECHANICS CO., LTD., Suwon-si (KR)

(21) Appl. No.: 19/270,584

(22) Filed: Jul. 16, 2025

(30) Foreign Application Priority Data
Aug. 21, 2024 (KR) 10-2024-0112111

(51) Int. Cl. H01F 27/28; H01F 27/32

(52) U.S. Cl. CPC H01F 27/2852; H01F 27/324

(57) ABSTRACT

A coil component includes a body having a first surface, a second surface opposing the first surface in a first direction, and a plurality of side surfaces connecting the first surface to the second surface. A coil is disposed within the body, and first and second external electrodes are provided, each including a first metal layer electrically connected to the coil and disposed on a side surface of the body. A first insulating layer is disposed on the side surface of the body, covering at least a portion of the first metal layer. Surface roughness is formed on at least a portion of the surface of the first metal layer in contact with the first insulating layer, wherein the surface roughness Ry is defined as a maximum height roughness with an average value of 1 μm or more, enhancing adhesion between the first metal layer and the first insulating layer.

### CROSS-REFERENCE TO RELATED APPLICATION(S)

This application claims the benefit of priority to Korean Patent Application No. 10-2024-0112111 filed on Aug. 21, 2024 in the Korean Intellectual Property Office, the disclosure of which is incorporated herein by reference in its entirety.

### BACKGROUND

### 1. Field

The present disclosure relates to a coil component.

### 2. Description of Related Art

An inductor, a coil component, may be a representative passive electronic component in an electronic device, along with a resistor and a capacitor.

As electronic devices have been designed to be high-performance and to have a reduced size, the number of electronic components used in an electronic device has increased while electronic devices have been designed to have a reduced size.

External electrodes of the coil component may be usually formed on two side surfaces of a body opposing each other in a length direction. In this case, an effective area loss of a magnetic material may occur due to thicknesses of the external electrode and the insulating layer covering the electrode. A thickness of the external electrode may be reduced by adjusting a plating thickness, direct current resistance (Rdc) may increase, such that there may be a limitation in application. Accordingly, the importance of a method for reducing a thickness of an insulating layer covering an external electrode has been emerged.

### SUMMARY

An aspect of the present disclosure is to provide a coil component in which a surface insulating layer may have a reduced thickness such that capacitance may increase.

An aspect of the present disclosure is to provide a coil component in which defects in applying a surface insulating layer may be addressed.

According to an aspect of the present disclosure, a coil component includes a body including a first surface, a second surface opposing the first surface in a first direction, and a plurality of side surfaces connecting the first surface to the second surface; a coil disposed in the body; first and second external electrodes including a first metal layer connected to the coil and disposed on a side surface of the body; and a first insulating layer disposed on the side surface of the body and covering at least a portion of the first metal layer, wherein surface roughness is formed on at least a portion of a surface of the first metal layer in contact with the first insulating layer, and wherein the surface roughness Ry has an average value of 1 μm or more.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to an embodiment of the present disclosure;

FIG. 2 is a diagram illustrating a coil in FIG. 1;

FIG. 3 is a diagram illustrating the example in FIG. 1, viewed in A direction;

FIG. 4 is a cross-sectional diagram taken along line I-I′ in FIG. 1;

FIG. 5 is an enlarged diagram illustrating portion B in FIG. 4;

FIG. 6 is a cross-sectional diagram taken along line II-II′ in FIG. 1;

FIG. 7 is a diagram illustrating a coil component according to another embodiment of the present disclosure;

FIG. 8 is a diagram illustrating an insulating layer in FIG. 7; and

FIG. 9 is a cross-sectional diagram taken along line III-III′ in FIG. 7.

### DETAILED DESCRIPTION

Hereinafter, embodiments of the present disclosure will be described as below with reference to the attached drawings.

The present disclosure may, however, be exemplified in many different forms and should not be construed as being limited to the specific embodiments set forth herein. An exhibition used in the singular encompasses the exhibition of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the exhibition that an element is disposed “on” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. To the contrary, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the X-direction may be defined as a first direction or a length direction, the Y-direction may be defined as a second direction or a width direction, and the Z-direction may be defined as a third direction or a thickness direction.

In the drawings, the same elements will be indicated by the same reference numerals. Also, redundant descriptions and detailed descriptions of known functions and elements which may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

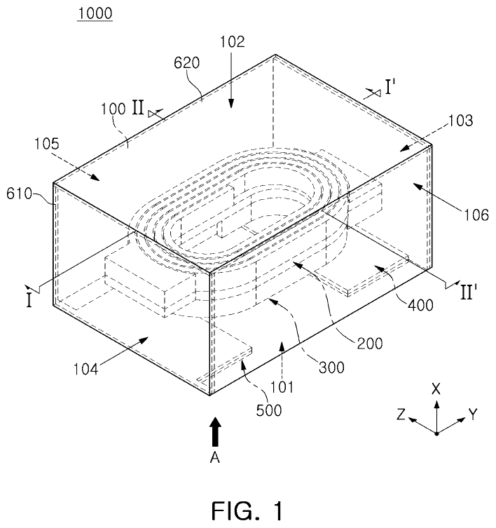

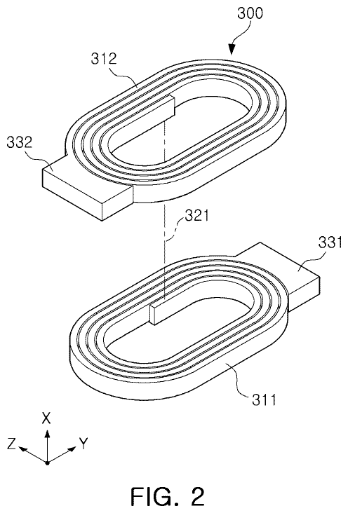

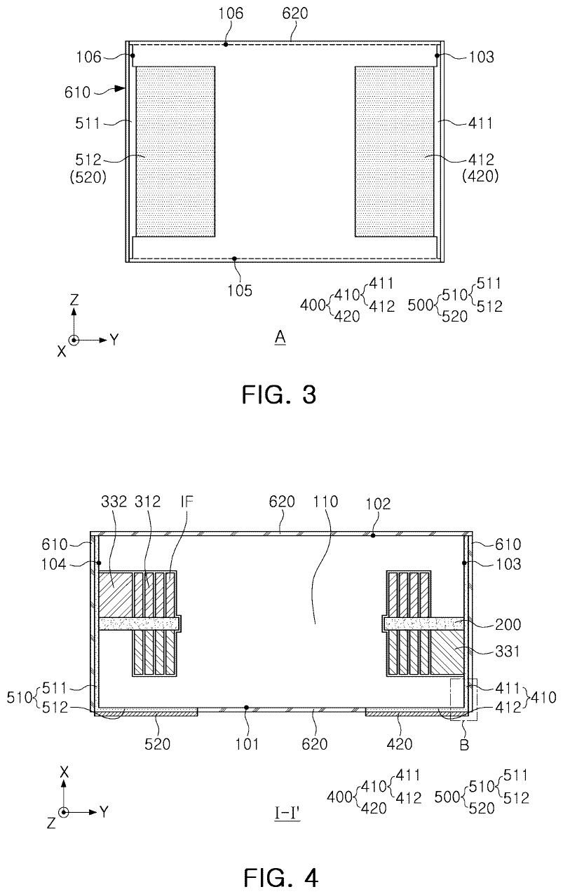

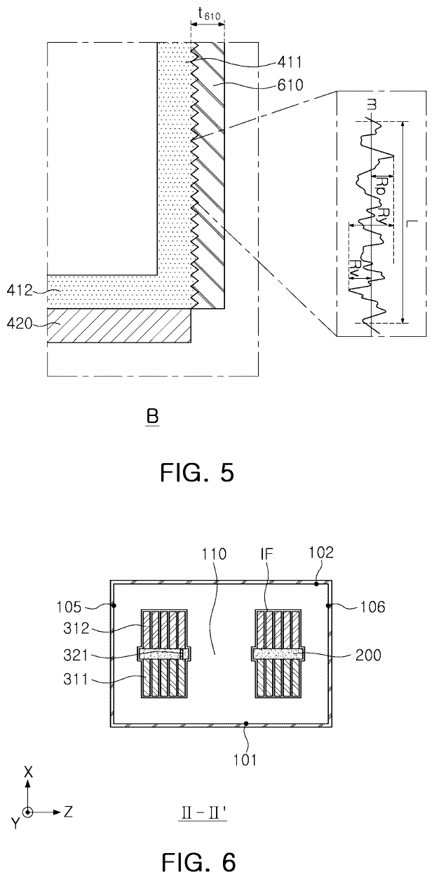

FIG. 1 is a perspective diagram illustrating a coil component according to an embodiment. FIG. 2 is a diagram illustrating a coil in FIG. 1. FIG. 3 is a diagram illustrating the example in FIG. 1, viewed in A direction. FIG. 4 is a cross-sectional diagram taken along line I-I′ in FIG. 1. FIG. 5 is an enlarged diagram illustrating portion B in FIG. 4. FIG. 6 is a cross-sectional diagram taken along line II-II′ in FIG. 1.

Referring to FIGS. 1 to 6, a coil component 1000 according to an embodiment includes a body 100, support member 200, coil 300, external electrodes 400 and 500, first and second insulating layers 610 and 620, and may further include insulating film IF.

The body 100 may form an overall exterior of the coil component 1000 in the embodiment, and the support member 200 and the coil 300 may be embedded therein. The body 100 may have a hexahedral shape.

In the description below, an embodiment may be described assuming that the body 100 has a hexahedral shape. However, this description does not exclude a coil component including a body formed in a shape other than a hexahedral from the scope in the embodiment.

The body 100 may include a first surface 101 and a second surface 102 opposing each other in the first direction (X-direction), a third surface 103 and a fourth surface 104 opposing each other in the second direction (Y-direction), and a fifth surface 105 and a sixth surface 106 opposing each other in the third direction (Z-direction). The third to sixth surfaces 103, 104, 105, and 106 may be side surfaces connecting the first surface 101 to the second surface 102. When mounting the coil component 1000 according to the embodiment on a printed circuit board or other mounting substrate, the first surface 101 of the body 100 may face a mounting surface of the mounting substrate and may be mounted on the mounting substrate.

The body 100 may be formed to have a coil component 1000 having a length of 2.0 mm, a width of 1.2 mm and a thickness of 0.65 mm according to the embodiment, in which external electrodes 400 and 500 and insulating layers 610 and 620 are formed, for example, as described below, but an embodiment thereof is not limited thereto. The dimensions of the length, width and thickness of the coil component described above may exclude process errors (tolerance), and the actual length, width and thickness of the coil component due to the tolerance may differ from the dimensions described above, and the range recognized as a tolerance may be included in the embodiments.

The length of the coil component 1000 described above may indicate a maximum value of a dimension of a plurality of line segments connecting two outermost side boundary lines of the coil component 1000 opposing each other in the second direction (Y-direction) illustrated in the image of the cross-section and parallel to the second direction (Y-direction) based on an image of a second direction (Y-direction)-first direction (X-direction) cross-section of a third direction (Z-direction) central portion of the coil component 1000, obtained by an optical microscope or scanning electron microscope (SEM). Alternatively, the length of the coil component 1000 described above may indicate an arithmetic mean value of at least three or more dimensions of a plurality of line segments connecting two outermost side boundary lines of the coil component 1000 opposing each other in the second direction (Y-direction) illustrated in the image of the cross-section and parallel to the second direction (Y-direction).

The thickness of the coil component 1000 described above may indicate, based on an image of a second direction (Y-direction)-first direction (X-direction) cross-section of a third direction (Z-direction) central portion of the coil component 1000, obtained by an optical microscope or scanning electron microscope (SEM), a maximum value of a dimension of a plurality of line segments connecting two outermost side boundary lines of the coil component 1000 opposing each other in the first direction (X-direction) illustrated in the image of the cross-section and parallel to the first direction (X-direction). Alternatively, the thickness of the coil component 1000 described above may indicate an arithmetic mean value of at least three or more dimensions of a plurality of line segments connecting two outermost side boundary lines of the coil component 1000 opposing each other in the first direction (X-direction) illustrated in the image of the cross-section and parallel to the first direction (X-direction).

The width of the coil component 1000 described above may indicate, based on an image of a third direction (Z-direction)-first direction (X-direction) cross-section of a second direction (Y-direction) central portion of the coil component 1000, obtained by an optical microscope or scanning electron microscope (SEM), a maximum value of a plurality of line segments connecting two outermost side boundary lines of the coil component 1000 opposing each other in the third direction (Z-direction) illustrated in the image of the cross-section and parallel to the third direction (Z-direction). Alternatively, the width of the coil component 1000 described above may indicate an arithmetic mean value of at least three or more dimensions of line segments connecting two outermost side boundary lines of the coil component 1000 opposing each other in the third direction (Z-direction) illustrated in the image of the cross-section.

Alternatively, each of the length, width and thickness of the coil component 1000 may be measured by a micrometer measurement method. The micrometer measurement method may be performed by setting a zero point with a Gage R&R (Repeatability and Reproducibility)-tested micrometer, inserting the coil component 1000 according to the embodiment between tips of the micrometer, and turning the measurement lever of the micrometer. In measuring the length of the coil component 1000 by the micrometer measurement method, the length of the coil component 1000 may indicate a value measured once, or may indicate an arithmetic mean of values measured multiple times, which may be equally applied to the width and thickness of the coil component 1000.

The body 100 may include magnetic powder and an insulating resin. Specifically, the body 100 may be formed by laminating one or more magnetic composite sheets including an insulating resin and magnetic powder dispersed in the insulating resin, and curing the magnetic composite sheet. However, the body 100 may have a structure other than a structure in which the magnetic powder is dispersed in an insulating resin. For example, the body 100 may be formed from a magnetic material such as ferrite.

The magnetic material included in the body 100 may be ferrite or a magnetic metal powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

Magnetic metal powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The magnetic metal powder may be amorphous or crystalline. For example, the magnetic metal powder may be an Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto. The average diameter of the magnetic metal powder may refer to a particle size distribution represented as D50 or D90.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The insulating resin may include epoxy, polyimide, a liquid crystal polymer, or the like, alone or in combination, but an embodiment thereof is not limited thereto.

The body 100 may include a core 110 penetrating central portions of the support member 200 and the coil 300, which will be described later. The core 110 may be formed by filling a through-hole through which a magnetic composite sheet penetrates the central portions of the coil portion 300 and the support member 200, but an embodiment thereof is not limited thereto.

The support member 200 may be disposed in the body 100 and may support the coil 300, which will be described later.

The support member 200 may be formed of an insulating material including a thermosetting insulating resin such as an epoxy resin, a thermoplastic insulating resin such as a polyimide, or a photosensitive insulating resin, or may be formed of an insulating material in which a reinforcing material such as glass fiber or an inorganic filler is impregnated into the insulating resin. For example, the support member 200 may be formed of an insulating material such as a copper clad laminate (CCL), a prepreg, an Ajinomoto build-up film (ABF), a FR-4, a bismaleimide triazine (BT) film, a photoimageable dielectric (PID) film, or the like, but an embodiment thereof is not limited thereto.

As the inorganic filler, at least one or more selected from a group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the support member 200 is formed of an insulating material including a reinforcing material, the support member 200 may provide better rigidity. When the support member 200 is formed of an insulating material not including glass fiber, the support member 200 may be advantageous in reducing a thickness of the entire coil 300. When the support member 200 is formed of an insulating material including a photosensitive insulating resin, the number of processes for forming the coil 300 is reduced, which may be advantageous in reducing production costs and fine vias may be formed.

The coil 300 may be disposed in the body 100 and may exhibit characteristics of the coil component. For example, when the coil component 1000 in the embodiment is used as a power inductor, the coil 300 may store an electric field as a magnetic field and may maintain an output voltage, thereby stabilizing power of the electronic device.

The coil 300 may be formed on at least one of both surfaces of the support member 200 opposing each other and may form at least one turn. The coil 300 may be disposed on one surface and the other surface of the support member 200 opposing each other in the thickness direction T of the body 100. In the embodiment, the coil 300 may include a first coil pattern 311 and a first lead-out pattern 331 disposed on one surface of a support member 200 opposing the first surface 101 of the body 100, a second coil pattern 312 and a second lead-out pattern 332 disposed on the other surface of the support member 200, and a via 321 penetrating the support member 200 and connecting inner ends of the first coil pattern 311 and the second coil pattern 312 to each other. Accordingly, the coil 300 according to the embodiment may function as a coil.

Each of the first coil pattern 311 and the second coil pattern 312 may be in the form of a planar helix forming at least one turn with the core 110 of the body 100 as an axis. For example, with respect to the directions in FIGS. 1, 2 and 4, the first coil pattern 311 may form at least one turn on the lower surface of the support member 200 with the core 110 as an axis. The second coil pattern 312 may form at least one turn on the upper surface of the support member 200 with the core 110 as an axis.

The lead-out patterns 331 and 332 may be connected to the coil patterns 311 and 312 and may be exposed to the third and fourth surfaces 103 and 104 of the body 100, respectively. Specifically, the first lead-out pattern 331 may be disposed on one surface of the support member 200, may be connected to the first coil pattern 311, and may be exposed to the third surface 103 of the body 100. The second lead-out pattern 332 may be disposed on the other surface of the support member 200, may be connected to the second coil pattern 312, and may be exposed to the fourth surface 104 of the body 100. The lead-out patterns 331 and 332 may be exposed to the third and fourth surfaces 103 and 104 of the body 100 and may be in contact with and connected to the first metal layers 410 and 510 of the external electrodes 400 and 500 described later.

At least one of the coil patterns 311 and 312, the via 321 and the lead-out patterns 331 and 332 may include at least one conductive layer.

For example, when the second coil pattern 312, the via 321 and the second lead-out pattern 332 are formed by plating, each of the second coil pattern 312, the via 321 and the second lead-out pattern 332 may include a seed layer formed by vapor deposition such as electroless plating or sputtering, and an electrolytic plating layer. Here, the electrolytic plating layer may have a single layer structure or a multilayer structure. The electrolytic plating layer of the multilayer structure may be formed as a conformal film structure in which one electrolytic plating layer is covered by another electrolytic plating layer, or may be formed in a shape in which another electrolytic plating layer is laminated only on one surface of one electrolytic plating layer. The seed layers of the second coil pattern 312, via 321 and the second lead-out pattern 332 may be integrated such that no boundary is formed therebetween, but an embodiment thereof is not limited thereto. The electroplating layers of the second coil pattern 312, the via 321 and the second lead-out pattern 332 may be integrated and no boundary may be formed therebetween, but an embodiment thereof is not limited thereto.

As another example, when the first coil pattern 311 and the first lead-out pattern 331 and the second coil pattern 312 and the second lead-out pattern 332 are formed separately and laminated together on the support member 200 and form the coil 300, the via 321 may include a high-melting-point metal layer and a low-melting-point metal layer having a melting point lower than the melting point of the high-melting-point metal layer. Here, the low-melting-point metal layer may be formed of a solder including lead (Pb) and/or tin (Sn). At least a portion of the low-melting-point metal layer may be melted due to pressure and temperature during lamination, such that an intermetallic compound layer (IMC Layer) may be formed on a boundary between the low-melting-point metal layer and the second coil pattern 312.

The first coil pattern 311 and the first lead-out pattern 331, and the second coil pattern 312 and the second lead-out pattern 332 may protrude on the lower surface and the upper surface of the support member 200, respectively, as illustrated in FIGS. 4 and 6, for example. As another example, the first coil pattern 311 and the first lead-out pattern 331 may be buried in the lower surface of the support member 200 such that a lower surface thereof may be exposed to the lower surface of the support member 200, and the second coil pattern 312 and the second lead-out pattern 332 may protrude on the upper surface of the support member 200. In this case, a concave portion may be formed on the lower surface of each of the first coil pattern 311 and the first lead-out pattern 331, such that the lower surface of the support member 200 and the lower surfaces of the first coil pattern 311 and the first lead-out pattern 331 may not be positioned on the same plane. As another example, the first coil pattern 311 and the first lead-out pattern 331 may protrude on the lower surface of the support member 200, and the second coil pattern 312 and the second lead-out pattern 332 may be buried in the upper surface of the support member 200, such that upper surfaces may be exposed to the upper surface of the support member 200. In this case, a concave portion may be formed on the upper surface of each of the second coil pattern 312 and the second lead-out pattern 332, such that the upper surface of the support member 200 and the upper surfaces of the second coil pattern 312 and the second lead-out pattern 332 may not be positioned on the same plane. As another example, the first coil pattern 311 may be buried in the lower surface of the support member 200, such that the lower surface may be exposed to the lower surface of the support member 200, and the second coil pattern 312 may be buried in the upper surface of the support member 200, such that the upper surface may be exposed to the upper surface of the support member 200.

Each of the coil patterns 311 and 312, the via 321 and the lead-out patterns 331 and 332 may be formed of a conductive material such as copper (Cu), aluminum (Al), silver (Ag), tin (Sn), gold (Au), nickel (Ni), lead (Pb), titanium (Ti), molybdenum (Mo), or an alloy thereof, but an embodiment thereof is not limited thereto.

The insulating film IF may be formed along surfaces of the support member 200 and the coil 300. The insulating film IF may protect the coil 300 and may insulate the coil 300 from the body 100 including a magnetic material of the conductive material, and may include a generally used insulating material such as parylene. The insulating material included in the insulating film IF may be any material, and there may be no particular limitation. The insulating film IF may be formed by a method such as vapor deposition, but an embodiment thereof is not limited thereto, and the insulating film may also be formed by laminating the insulating film to both surfaces of the support member 200.

The external electrodes 400 and 500 may be disposed on the side surface of the body and may include the first metal layer 410 and 510 connected to the coil 300. Referring to FIG. 4, the first metal layer 410 of the first external electrode may be disposed on the body third surface 103 and may be connected to the first lead-out pattern 331, and the first metal layer 510 of the second external electrode may be disposed on the fourth surface 104 of the body and may be connected to the second lead-out pattern 332.

The external electrodes 400 and 500 may extend to the first surface of the body 101. That is, the first metal layer 410 and 510 may include connection portions 411 and 511 disposed on the side surface of the body and pad portions 412 and 512 extending to the first surface of the body 101.

The connection portions 411 and 511 may be disposed on the side surface of the body and may be directly connected to the coil 300. That is, the connection portions 411 and 511 of the first metal layers 410 and 510 may be connected to the first and second lead-out patterns 331 and 332.

The pad portions 412 and 512 may extend from the connection portions 411 and 511 to the first surface of the body 101. Specifically, the first metal layer 410 of the first external electrode may include the first connection portion 411 disposed on the body third surface 103 and the first pad portion 412 extending to the first surface of the body 101. Similarly, the first metal layer 510 of the second external electrode may include a second connection portion 511 disposed on the fourth surface 104 of the body and a second pad portion 512 extending to the first surface of the body 101.

The first and second external electrodes 400 and 500 may be spaced apart from each other on the first surface of the body 101. That is, the first pad portion 412 and the second pad portion 512 may be spaced apart from each other on the first surface of the body 101.

The first metal layer 410 and 510 of the external electrodes 400 and 500 may be formed on the surface of the body 100 by forming a plating resist on the surface of the body 100 and performing electroplating. When the body 100 includes a magnetic metal powder, the magnetic metal powder may be exposed on the surface of the body 100. Due to the magnetic metal powder exposed on the surface of the body 100, conductivity may be provided to the surface of the body 100 during electroplating, and the first metal layer 410 and 510 may be formed on the surface of the body 100 by electroplating.

The connection portions 411 and 511 and the pad portions 412 and 512 of the first metal layer 410 and 510 may be formed by the same plating process, such that no boundary may be formed therebetween. That is, the first connection portion 411 and the first pad portion 412 may be integrated with each other, and the second connection portion 511 and the second pad portion 512 may be integrated with each other. Also, the connection portions 411 and 511 and the pad portions 412 and 512 may be formed of the same metal. However, this description does not exclude the example in which the connection portions 411 and 511 and the pad portions 412 and 512 may be formed by different plating processes and a boundary therebetween may be formed. The first metal layers 410 and 510 may be formed of a conductive material such as copper (Cu), aluminum (Al), silver (Ag), tin (Sn), gold (Au), nickel (Ni), lead (Pb), titanium (Ti), or an alloy thereof, but an embodiment thereof is not limited thereto. As an example, although not limited thereto, the first metal layers 410 and 510 may be copper (Cu) plating layers.

The first metal layers 410 and 510 may have a thickness of 0.3 μm to 10 μm. When the thickness of the first metal layer 410 and 510 is less than 0.3 μm, detachment and peeling of the external electrodes 400 and 500 may occur during substrate mounting, and connection reliability between the coil portion 300 and the external electrodes 400 and 500 may deteriorate. When the thickness of the first metal layer 410 and 510 exceeds 10 μm, reduction of a thickness of the coil component may not be easily performed, and process efficiency may deteriorate.

Referring to FIG. 5, the first metal layer 410 and 510 may be covered by the first insulating layer 610, which will be described later. That is, the first metal layer 410 and 510 may be in direct contact with the first insulating layer 610 on side surfaces 103 and 104 of the body. In this case, surface roughness may be formed on at least a portion of the surfaces of the first metal layers 410 and 510 in contact with the first insulating layer 610. Specifically, surface roughness may be formed on at least a portion of the first connection portion 411 and the second connection portion 511.

Since surface roughness is formed on a boundary surface of the first metal layers 410 and 510 in contact with the first insulating layer 610, a thickness of the first insulating layer 610 may be uniformly reduced. Also, bonding force between the first metal layers 410 and 510 and the first insulating layer 610 may be improved.

The first insulating layer 610 may be formed by transferring the paste as described below, and it may be necessary to increase the amount of paste transfer in order to ensure the flatness of the thickness of the insulating layer. However, accordingly, the thickness of the first insulating layer 610 may increase, which may be disadvantageous in terms of the effective magnetic area.

The coil component according to the embodiment may form roughness on the surface of the first metal layer 410 and 510 on which the first insulating layer 610 is disposed. In the case of a metal having high surface energy, as surface roughness increases, flowability of the material applied on the metal may be improved. When the surface roughness is formed on the first metal layer 410 and 510, flowability may be improved when forming the first insulating layer 610, and the thickness of the insulating layer may be reduced and uniformed even when the amount of paste transfer is reduced.

Specifically, the surface roughness Ry of the first metal layer 410 and 510 may have an average value of 1 μm or more. When the surface roughness is less than 1 μm, the flatness may not be sufficiently improved, and the defect of exposure of external electrode and pin hole defect may occur.

The surface roughness Ry of the first metal layer 410 and 510 may have an average value of 10 μm or less. When the surface roughness of the first metal layer 410 and 510 exceeds 10 μm, excessive roughness may cause an adverse effect in which the paste is not partially transferred. In other words, an exposure defect in which a portion of the external electrode is exposed may occur.

[Table 1] below lists results of characteristic evaluation according to the surface roughness Ry value formed on the first metal layer 410 and 510. When the same amount of paste was transferred, the exposure defect, pin hole defect, and flatness of the external electrode were measured.

TABLE 1

| | | | Evaluation results | | |
|---|---|---|---|---|---|
| | Surface | | Exposure defect | Pin hole | |
| | roughness | | (number of | defect(number of | Flatness |
| Condi- | Ry (AVE, | | defects/SPL | defects/SPL | (AVE, |
| tions | n = 10 | | parameter) | parameter) | n = 10 |
| 1 | 0 | μm | 18/100 | 45/100 | 11.1 |
| 2 | 0.14 | μm | 13/100 | 38/100 | 9.1 |
| 3 | 0.89 | μm | 0/100 | 7/100 | 3.4 |
| 4 | 1.23 | μm | 0/100 | 0/100 | 1.7 |
| 5 | 2.24 | μm | 0/100 | 0/100 | 1.6 |
| 6 | 2.83 | μm | 0/100 | 0/100 | 1.5 |
| 7 | 3.78 | μm | 0/100 | 0/100 | 1.5 |
| 8 | 4.68 | μm | 0/100 | 0/100 | 1.4 |
| 9 | 6.78 | μm | 0/100 | 0/100 | 1.7 |
| 10 | 8.01 | μm | 0/100 | 0/100 | 1.5 |
| 11 | 10.14 | μm | 6/100 | 0/100 | 1.6 |
| 12 | 12.85 | μm | 11/00 | 0/100 | 1.6 |
| 13 | 15.27 | μm | 15/100 | 0/100 | 1.6 |

Referring to [Table 1], when the surface roughness Ry is less than 1 μm, the flatness may not be sufficiently improved, and the exposure defect and pin hole defect of the external electrode may occur. That is, in order to improve the exposure defect and pin hole defect of the external electrode, the amount of paste transfer may need to be increased, and accordingly, the thickness of the first insulating layer 610 may be increased.

When the surface roughness Ry exceeds 10 μm, the reverse effect in which the paste is not partially transferred due to excessive roughness may occur. That is, the exposure defect in which a portion of the external electrode is exposed may occur.

The surface roughness according to the embodiment may indicate the maximum height roughness Ry. The maximum height roughness Ry may be a value measured from a distance between the highest peak line and the lowest valley line from the virtual central line of the surface roughness curve.

The method of measuring the surface roughness may be as below. First, a first-second direction cross-section sample may be obtained by grinding to a depth of ½ in the third direction (Z-direction). In the obtained cross-section, a distance between the highest peak line and the lowest valley line may be measured in a reference length of 10 μm along the first metal layer 410 and 510. Referring to FIG. 5, the maximum height roughness Ry may be calculated by adding the distance Rp from the central line m to the highest peak line and the distance Rv from the central line m to the lowest valley line. The number of samples may be 20, and the maximum height roughness Ry measured once per sample may be an arithmetic average, which may be the surface roughness according to the embodiment, but an embodiment thereof is not limited thereto.

The method of providing surface roughness to the connection portions 411 and 511 is not limited to any particular example. For example, in order to provide surface roughness to the connection portions 411 and 511, plasma surface treatment may be performed, or a chemical processing method such as anisotropic etching may be used. Also, surface roughness may be provided to the connection portions 411 and 511 by forming an oxide, or surface roughness may be provided by changing the plating process conditions and performing rough plating.

Surface roughness may not be formed on a surface of the first metal layer 410 and 510 not in contact with the first insulating layer 610. Specifically, surface roughness may not be formed on the first pad portion 412 and the second pad portion 512, or surface roughness smaller than the surface roughness formed on the first connection portion 411 and the second connection portion 511 may be formed. As described below, the second metal layer 420 and 520 may be disposed on the first pad portion 412 and the second pad portion 512.

The external electrodes 400 and 500 may further include a second metal layer 420 and 520 disposed on the first surface of the body 101. The second metal layer 420 and 520 may be disposed on pad portions 412 and 512 of the first metal layer 410 and 510. Specifically, the second metal layer 420 of the first external electrode 400 may be disposed on the first pad portion 412, and the second metal layer 520 of the second external electrode 500 may be disposed on the second pad portion 512. The second metal layer 420 and 520 may be a plating layer grown on the pad portions 412 and 512 opened externally by the first and second insulating layers 610 and 620, which will be described later. For example, each of the second metal layers 420 and 520 may include a nickel (Ni) plating layer disposed on the pad portions 412 and 512, and a tin (Sn) plating layer disposed on the nickel (Ni) plating layer, but an embodiment thereof is not limited thereto.

The second metal layers 420 and 520 may be formed in a thickness range of 0.3 μm to 10 μm. When the thickness of the second metal layers 420 and 520 is less than 0.3 μm, detachment and peeling of the second metal layers 420 and 520 may occur during substrate mounting, and connection reliability between the coil portion 300 and the external electrodes 400 and 500 may deteriorate. When the thickness of the second metal layers 420 and 520 exceeds 10 μm, reduction of a thickness of the coil component may not be easily performed, and process efficiency may deteriorate.

The first insulating layer 610 may be disposed on the side surface of the body and may cover at least a portion of the first metal layer 410 and 510. Specifically, the first insulating layer 610 may be disposed on the third surface 103 and the fourth surface 104 of the body and may cover the first connection portion 411 of the first metal layer 410 and the second connection portion 511 of the second metal layer 510.

The first insulating layer 610, together with the second insulating layer 620 described later, may cover the connection portions 411 and 511 of the first metal layer 410 and 510 and may open at least a portion of the pad portions 412 and 512 of the first metal layer 410 and 510. That is, the first insulating layer 610 may not be in contact with at least a portion of the pad portions 412 and 512.

The first insulating layer 610 may function as a plating resist when the second metal layers 420 and 520 are formed by plating. Accordingly, after the first metal layers 410 and 510 of the external electrodes 400 and 500 are formed, the first insulating layer 610 may be formed on the body 100 in a form of covering the connection portions 411 and 511 and opening the pad portions 412 and 512, thereby defining a region in which the second metal layers 420 and 520 are formed together with the second insulating layer 620. However, this embodiment is not limited thereto.

The first insulating layer 610 may include a thermoplastic resin such as polystyrene, vinyl acetate, polyester, polyethylene, polypropylene, polyamide, rubber, or acrylic, a thermosetting resin such as phenol, epoxy, urethane, melamine, or alkyd, a photosensitive resin, parylene, SiOx, or SiNx.

The first insulating layer 610 may be formed by applying a liquid insulating resin to the surface of the body 100, applying an insulating paste to the surface of the body 100, laminating an insulating film on the surface of the body 100, or forming an insulating resin on the surface of the body 100 by vapor deposition. Alternatively, the first insulating layer 610 may be formed by disposing a material for forming the first insulating layer on a silicon die and stamping the body 100 on the silicon die. In the case of the insulating film, a dry film (DF) including a photosensitive insulating resin, an Ajinomoto build-up film (ABF) not including a photosensitive insulating resin, or a polyimide film, or the like, may be used.

The first insulating layer 610 may have an adhesive function. For example, when the insulating film is formed by laminating the body 100 and forming the first insulating layer 610, the insulating film may include an adhesive component and may be adhered to the surface of the body 100. In this case, an adhesive layer may be formed separately on one surface of the first insulating layer 610. However, in the case in which the first insulating layer 610 is formed using an insulating film in a semi-cured state (B-stage), a separate adhesive layer may not be formed on one surface of the first insulating layer 610.

The thickness t₆₁₀ of the first insulating layer 610 may be 10 μm or less. When the thickness of the first insulating layer 610 exceeds 10 μm, the total length of the coil component increases, which is disadvantageous for reducing a thickness, and the effective volume of the magnetic material decreases as compared to the same volume of the component, such that the characteristics of the component may be deteriorated. As described above, the coil component according to the embodiment may form surface roughness on at least a portion of the first and second metal layers 410 and 510, such that even when a small amount of paste is transferred, the flatness of the first insulating layer 610 may be improved, and a thickness of the first insulating layer 610 may be reduced.

The thickness t₆₁₀ of the first insulating layer 610 may be 10 nm or more. When the thickness of the first insulating layer 610 is less than 10 nm, the characteristics of the coil component, such as a decrease in Q factor, a decrease in breakdown voltage, and a decrease in self-resonant frequency (SRF), may be decreased.

The thickness t₆₁₀ of the first insulating layer 610 may be measured in the manner as below. First, a first-second direction cross-section sample may be collected by grinding to a depth of ½ in the third direction (Z-direction). The length in the second direction (Y-direction) of the first insulating layer 610 from the obtained cross-section sample may be measured multiple times, and the arithmetic mean of the measured values may be used as the thickness t₆₁₀ of the first insulating layer 610. For example, the arithmetic mean of the values measured at five different points in the first direction (X-direction) may be calculated, but an embodiment thereof is not limited thereto.

The second insulating layer 620 may be disposed on the first surface of the body 101 and may open at least a portion of each of the pad portions 412 and 512. In the embodiment, the second insulating layer 620 may cover the first to sixth surfaces 101, 102, 103, 104, 105, 106 of the body 100 other than the region in which the first metal layers 410 and 510 are disposed. Specifically, in the embodiment, since the first metal layers 410 and 510 are disposed on the third surface and fourth surface 103 and 104 of the body and a portion of the first surface 101, the second insulating layer 620 may cover the second surface 102, the fifth surface 105 and the sixth surface 106 of the body, and may be disposed on the region other than the region in which the pad portions 412 and 512 of the first surface 101 are disposed. The second insulating layer 620 disposed on the first surface 101, the second surface 102, the fifth surface 105 and the sixth surface 106 of the body 100 may be formed together in the same process such that a boundary may not be formed therebetween, but an embodiment thereof is not limited thereto. The second insulating layer 620 may function as a plating resist when the first metal layer 410 and 510 of the external electrodes 400 and 500 is formed by plating on the surface of the body 100. Accordingly, the second insulating layer 620 may be formed on the surface of the body 100 before the first metal layer 410 and 510 of the external electrodes 400 and 500, such that a region on the surface of the body 100 in which the first metal layer 410 and 510 is formed may be defined. However, this embodiment is not limited thereto.

The second insulating layer 620 may include a thermoplastic resin such as polystyrene, vinyl acetate, polyester, polyethylene, polypropylene, polyamide, rubber, or acrylic, a thermosetting resin such as phenol, epoxy, urethane, melamine, or alkyd, a photosensitive resin, parylene, SiOx, or SiNx.

The second insulating layer 620 may be formed by applying a liquid insulating resin to the surface of the body 100, applying an insulating paste to the surface of the body 100, laminating an insulating film to the surface of the body 100, or forming an insulating resin on the surface of the body 100 by vapor deposition. In the case of the insulating film, a dry film (DF) including a photosensitive insulating resin, an Ajinomoto build-up film (ABF) not including a photosensitive insulating resin, or a polyimide film, or the like, may be used.

The second insulating layer 620 may have an adhesive function. For example, when forming the second insulating layer 620 by laminating the insulating film on the body 100, the insulating film may include an adhesive component and may adhere to the surface of the body 100. In this case, an adhesive layer may be formed separately on one surface of the second insulating layer 620. However, in the case in which the second insulating layer 620 is formed using an insulating film in a semi-cured state (B-stage), a separate adhesive layer may not be formed on one surface of the second insulating layer 620.

The second insulating layer 620 may be formed in a thickness range of 10 nm to 10 μm. When the thickness of the second insulating layer 620 is less than 10 nm, the characteristics of the coil component may deteriorate, such as a decrease in the Q factor (Q factor), a decrease in the breakdown voltage, and a decrease in the self-resonant frequency (SRF). When the thickness of the second insulating layer 620 exceeds 10 μm, the total length, width, and thickness of the coil component may increase, which may be disadvantageous for reducing a thickness, and the effective volume of the magnetic material decreases as compared to a component of the same volume, which may deteriorate characteristics of the component.

### Second Embodiment

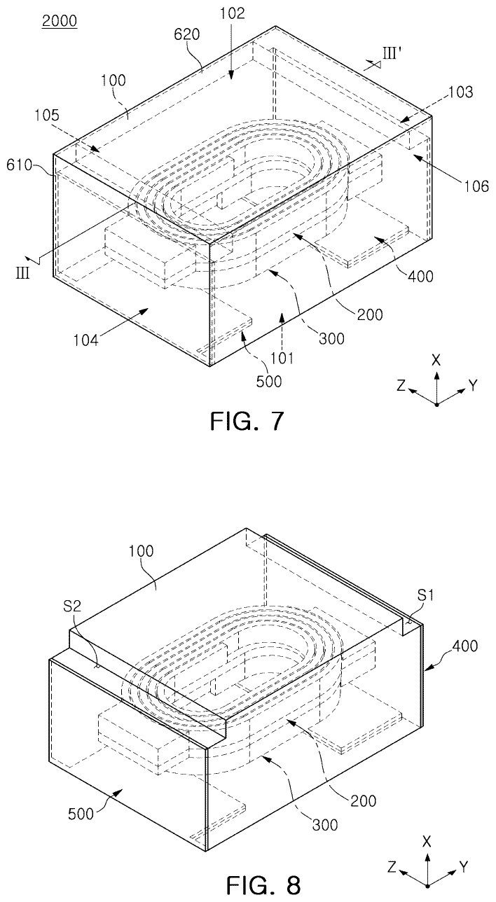

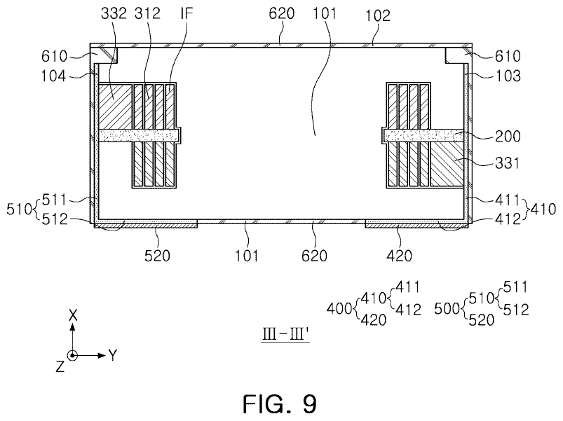

FIG. 7 is a diagram illustrating a coil component according to another embodiment. FIG. 8 is a diagram illustrating an insulating layer in FIG. 7. FIG. 9 is a cross-sectional diagram taken along line III-III′ in FIG. 7.

Referring to FIGS. 7 to 9, the external electrodes 400 and 500 of the coil component 2000 according to the second embodiment may be spaced apart from the second surface 102 of the body 100. Specifically, the first and second external electrodes 400 and 500 may not extend to the second surface of the body 102 and may maintain a predetermined distance from the second surface 102.

Referring to FIG. 8, the body 100 of the coil component 2000 according to the second embodiment may include a step portion S at an edge formed by the second surface 102 and a plurality of side surfaces. Specifically, a first step portion S1 may be formed at an edge formed by the second surface of the body 102 and the third surface 103, and a second step portion S2 may be formed at an edge formed by the second surface of the body 102 and the fourth surface 104. The first and second step portions S1 and S2 may extend in the third direction (Z-direction) of the body 100.

Referring to FIG. 9, the first insulating layer 610 may be disposed in the first and second step portions S1 and S2. That is, in order to prevent the external electrodes 400 and 500 from excessively extending to the second surface of the body 102, the coil component 2000 according to the second embodiment may form the step portions S1 and S2 at the edge of the body 100, and the insulating layer 610 may be disposed in the step portions S1 and S2.

Other than the descriptions above, the descriptions of the coil component 1000 according to the first embodiment may be applied as is, and the overlapping detailed descriptions may not be provided.

According to the aforementioned embodiments, a coil component in which a surface insulating layer may have a reduced thickness such that capacitance may increase may be provided.

Also, a coil component in which defects in applying a surface insulating layer may be addressed may be provided.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface, a second surface opposing the first surface in a first direction, and a plurality of side surfaces connecting the first surface to the second surface;
a coil disposed in the body;
first and second external electrodes including a first metal layer connected to the coil and disposed on a side surface of the body; and
a first insulating layer disposed on the side surface of the body and covering at least a portion of the first metal layer,
wherein surface roughness is formed on at least a portion of a surface of the first metal layer in contact with the first insulating layer, and
wherein the surface roughness Ry has an average value of 1 μm or more.

2. The coil component of claim 1, wherein the surface roughness Ry has an average value of 10 μm or less.

3. The coil component of claim 2, wherein a thickness of the first insulating layer is 10 μm or less.

4. The coil component of claim 1,
wherein the body includes a step portion located at an edge and formed by the second surface and the plurality of side surfaces of the body, and
wherein the first insulating layer is disposed in the step portion.

5. The coil component of claim 4, wherein the first and second external electrodes are spaced apart from the second surface of the body.

6. The coil component of claim 1, wherein the first metal layer includes a connection portion disposed on the side surface of the body and a pad portion extending to the first surface of the body.

7. The coil component of claim 6, wherein the connection portion is in direct contact with the coil.

8. The coil component of claim 6, wherein the first insulating layer covers at least a portion of the connection portion.

9. The coil component of claim 6, wherein the first insulating layer is not in contact with at least a portion of the pad portion.

10. The coil component of claim 6, wherein the first and second external electrodes further include a second metal layer disposed on the pad portion.

11. The coil component of claim 1, further comprising:
a support member disposed in the body,
wherein the coil includes first and second coil patterns disposed on one surface and another surface of the support member, respectively, and first and second lead-out patterns connected to the first and second coil patterns, respectively.

12. The coil component of claim 11, wherein the first metal layer of the first and second external electrodes is connected to each of the first and second lead-out patterns.

13. The coil component of claim 1, further comprising:
a second insulating layer disposed in a region of the first surface of the body in which the first metal layer is not disposed.

14. A coil component, comprising:
a body including a first surface, a second surface opposing the first surface in a first direction, and a plurality of side surfaces connecting the first surface to the second surface, and a step portion located at an edge formed by the second surface and the plurality of side surfaces;
a coil disposed in the body;
first and second external electrodes including a first metal layer connected to the coil and disposed on a side surface of the body; and
a first insulating layer disposed on the side surface and the step portion of the body and covering at least a portion of the first metal layer,
wherein surface roughness is formed on at least a portion of a surface of the first metal layer in contact with the first insulating layer.

15. The coil component of claim 14, wherein the surface roughness Ry has an average value of 10 μm or less.

16. The coil component of claim 14, wherein a thickness of the first insulating layer is 10 μm or less.
